(19) United States
(12) Patent Application Publication
(10) Pub. No.: US 2009/0091630 A1
(43) Pub. Date: Apr. 9, 2009

(54) FLEXIBLE MOUNTABLE SOFTWARE CONTROLLABLE LED RINGLIGHT

(76) Inventor: Rolf Bollhorst, Charlotte, NC (US)

Correspondence Address: ADAMS INTELLECTUAL PROPERTY LAW, P.A., Suite 2350 Charlotte Plaza, 201 South College Street, CHARLOTTE, NC, 28244, US

(21) Appl. No.: 12/236,204

(22) Filed: Sep. 23, 2008

Related U.S. Application Data
(60) Provisional application No. 60/978,166, filed on Oct. 8, 2007.

(51) Int. Cl. H04N 5/225

(52) U.S. Cl. 348/207.11; 348/E05.024

(57) ABSTRACT

An image acquisition system including a housed ringlight for providing illumination to an object to be photographed, and a mounting system for camera attachment, the camera having a camera power supply. A camera power output jack and a camera communication jack are provided, and a power connector is electrically connected to a power input jack of the ringlight to supply power from the camera. A ringlight communication jack and communication connector are provided for interconnecting the ringlight and the camera through the camera communication jack, and a data communication connector is provided for connecting the camera to a computer including software for controlling the camera and the ringlight.

### CROSS-REFERENCE TO RELATED APPLICATION

This application claims priority to U.S. Provisional Patent Application No. 60/978,166 filed Oct. 8, 2007, the contents of which are hereby incorporated by reference.

### TECHNICAL FIELD AND BACKGROUND OF THE INVENTION

This invention relates in general to machine vision systems using CCD or CMOS cameras, image acquisition systems and a user or software controlled ringlight for the illumination of objects to be photographed by the camera.

A “ring flash” or “ringlight” is a type of circular photographic light source positioned about a camera lens. The primary function of the light is to provide bright and homogeneous illumination to a specific area from a specific distance. Automated or user controlled machine vision applications for object inspection require stable, reproduceable and homogeneous illumination. LED ring illumination techniques using a lighting apparatus placed in front, behind or to the side of an image acquisition system is known in the art. These apparatuses provide high quality illumination, particularly where even, controlled lighting with an absence of shadow is important, as in commercial and scientific photography. Disadvanatges of known ringlight devices are that they are inflexible and difficult to mount, they are not powered by the camera and require an extra external power supply, they are not camera synchronized, and are not software controllable. It is thus apparent that there exists a need for improved control mechanisms and improved mounting techniques and devices.

### SUMMARY OF THE INVENTION

Therefore, it is an object of the present invention to provide a ringlight illumination system and a ringlight illumination system including a mounting system. The ringlight is software controllable, camera powered and can be easily mounted and adjusted to cameras equipped with various image acquisition systems. The ringlight is electrically connected to the camera and the camera is electrically connected to a computer interface. When in use with a camera that does not have its own power supply, the ringlight has a power jack for connection to external power. The system includes a circular array of LEDs which are equally and density spaced and placed around a circular opening. The LEDs have a specified aperture angle and intensity to provide a homogeneous illuminated area in a specific distance from the ringlight.

These and other objects of the invention are achieved by providing an image acquisition system, comprising a ringlight for providing illumination to an object to be photographed, and including a housing for mounting a camera having a camera power supply, a camera power output jack and a camera communication jack, a power connector electrically connected to a power input jack of the ringlight, and adapted for connection to the camera power output jack for transmitting electrical power from the camera power supply to the ringlight; a ringlight communication jack and communication connector for interconnecting the ringlight and the camera through the camera communication jack, and a data communication connector for connecting the camera to a computer including software for controlling the camera and the ringlight.

According to another embodiment of the invention, the ringlight includes a plurality of light-emitting diodes (“LED's”) surrounding an opening in the housing through which light transmitted by the LED's onto the object is reflected from the object to the camera.

According to yet another embodiment of the invention, the ringlight includes a cable containing both the power cables and communication/data cables.

According to yet another embodiment of the invention, the software functions to turn on the ringlight to provide continuous illumination for a predetermined time period and provide illumination duration and illumination in synchronization with the camera shutter, or to strobe the ringlight in response to an external signal.

According to yet another embodiment of the invention, an external power input jack is provided to power the ringlight from a power source other than the camera.

According to yet another embodiment of the invention, an image acquisition system includes a ringlight connected by a power/communications cable to a camera, the camera being adapted for connection via a communication cable to a computer communication interface, and a software user interface adapted to turn the ringlight on and off and control a plurality of ringlight functions.

According to yet another embodiment of the invention, the system includes computer software adapted to automatically control the ringlight according to predefined software instructions without user interaction.

According to yet another embodiment of the invention, the ringlight includes a plurality of light-emitting diodes (“LED's”) surrounding an opening in a ringlight housing through which light transmitted by the LED's onto an object is reflected from the object to the camera.

According to yet another embodiment of the invention, a ringlight is provided for use with an image acquisition system including a lens, a camera and a computer for permitting operation of the camera and ringlight, and includes a DC voltage regulator module for accepting a DC input voltage and converting an output voltage into a controllable forward current that serves as a current source for a driver module for powering illumination sources carried by the ringlight, and a brightness control module having a strobe signal input and a serial peripheral interface bus input electrically connected to the driver module for permitting the ringlight to be turned on and off in synchronization with an electronic shutter of the camera.

According to yet another embodiment of the invention, the serial peripheral interface bus input is adapted to adjust the brightness of the ringlight.

According to yet another embodiment of the invention, the ringlight includes a plurality of light-emitting diodes (“LED's”) surrounding an opening in a ringlight housing through which light transmitted by the LED's onto an object is reflected from the object to the camera.

### BRIEF DESCRIPTION OF THE DRAWINGS

Some of the objects of the invention have been set forth above. Other objects and advantages of the invention will appear as the description of the invention proceeds when taken in conjunction with the following drawings, in which:

FIG. 1 is a perspective view of a ringlight and mounting system according to an embodiment of the present invention;

FIG. 2 is a front view of the ringlight according to an embodiment of the present invention;

FIG. 3 is a back view of the ringlight according to an embodiment of the present invention;

FIG. 4 shows a ringlight according to an embodiment mounted to a camera equipped with an image acquisition system;

FIG. 5 shows the camera mounting system of the ringlight;

FIG. 6 shows the printed circuit board of the ringlight;

FIG. 7 shows the block diagram of the electronics; and

FIG. 8 shows a complete system consisting of a ringlight mounted to a camera with an image acquisition system and the camera mounted to a computer and a user interface.

### DESCRIPTION OF THE PREFERRED EMBODIMENTS AND BEST MODE

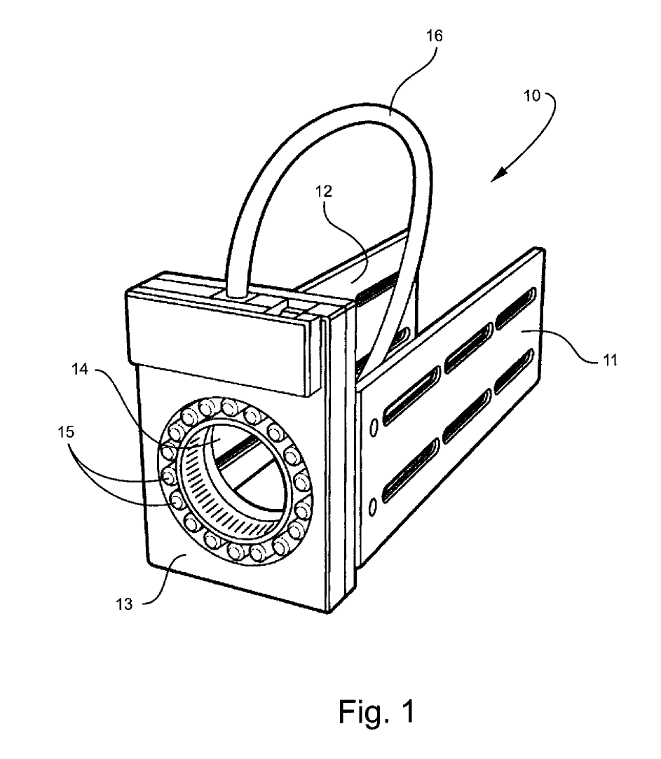

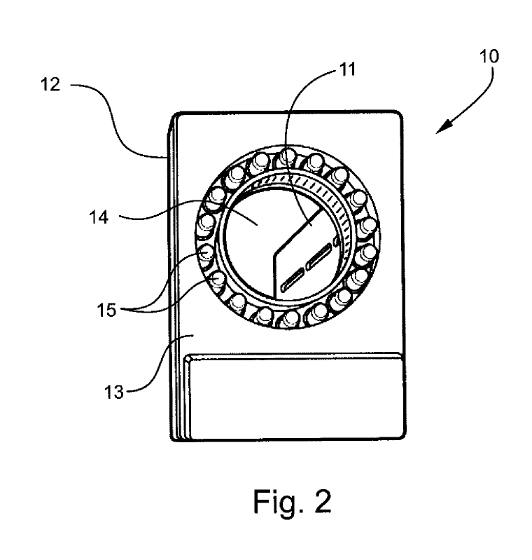

Referring now specifically to the drawings, an LED ringlight according to the present invention is shown generally in FIGS. 1-3 at reference numeral 10. The ringlight 10 includes a camera mounting system including a pair of side panels 11 and 12 and a front face 13 defining an opening 14 surrounded by an array of LEDs 15. The plurality of LED's surround the opening in the housing through which light transmitted by the LED's onto the object is reflected from the object to the camera. While a wide variety of LEDS can be used depending on the operating requirements of a particular camera and use, one suitable and non-limiting example of an LED includes a 5 mm, 40-50 degree, round, water clear LED. In the embodiment shown, nineteen such LED's 15 are positioned around the opening 14. A power/data cable 16 permits the LEDs 15 to be controlled by the camera, as described in further detail below.

The LEDs are preferably turned on simultaneously. The LEDs 15 can be automatically turned off and on, and dimmed either by use of the software provided, or manually by the user setting parameters in a software user interface. This is important to establish reproducible object illuminations because machine vision algorithms require defined light situations to function reliably. Furthermore, the ringlight 10 can be strobed either in synchronization to the camera's electronic shutter, or user controlled via a user interface. In an alternative embodiment, each of the LEDs 15 may be individually controlled, or groups of LEDs may be controlled.

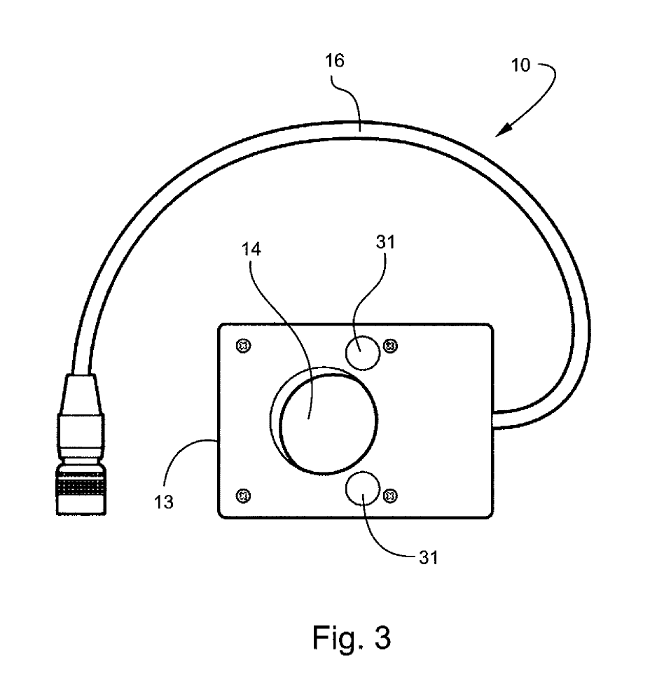

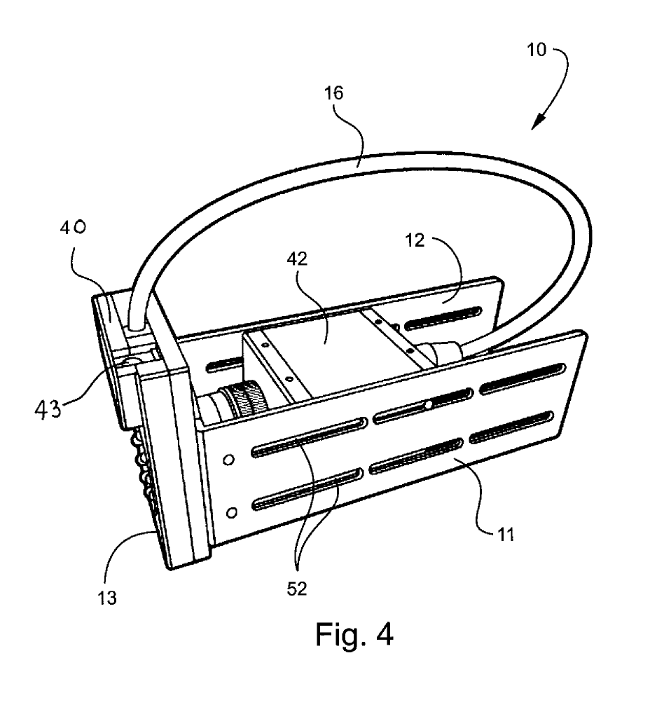

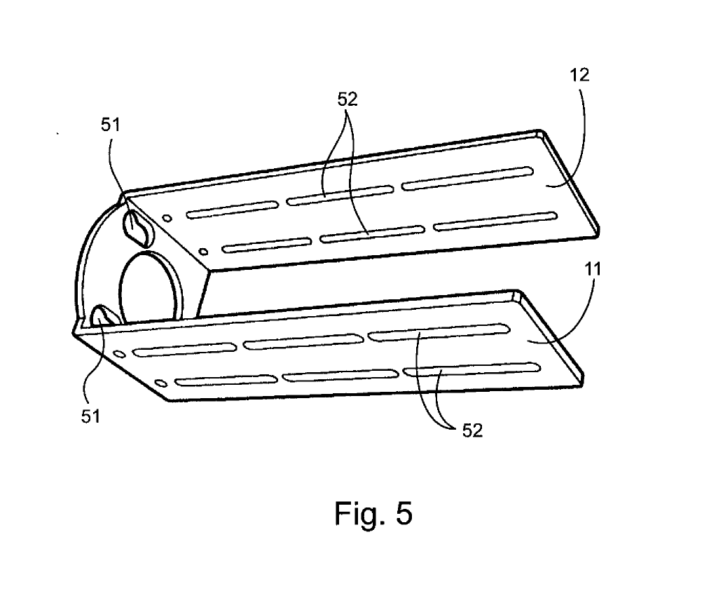

As best shown in FIG. 3, back of the front face 13 includes two round fittings 31. Under light pressure the round fittings 31 snap, as shown in FIG. 5, into key holes 51 in the side panels 11, 12 of the mounting system to achieve a solid attachment. Thus, the ringlight portion may be removed from the camera mounting system shown in FIG. 4. The power/data cable 16 includes a fitting for electrically and operationally attaching the ringlight 10 to a camera.

Referring now to FIG. 4, the ringlight 10 includes a printed circuit board 40 mounted on the front face 13. The front face 13 also has openings for a power input jack 43 and cable. Under light pressure, the front face 13 carrying the circuit board 40 can be detached from the side panels 11 and 12 and replaced with other ringlights having LEDs emitting different colors. A camera 42 is shown mounted between and maintained by the side panels 11, 12 and functionally connected to the ringlight 10 through the power/data cable 16. A lens of the camera 42 is positioned about or within the opening 14 of the front face 13.

As shown in FIGS. 4 and 5, the side panels 11 and 12 include slots 52 to conventionally mount the camera 42. The slots 52 are elongated to permit sliding and adjustment of the ringlight 10 to another image acquisition system with other dimensions, or another camera with other dimensions.

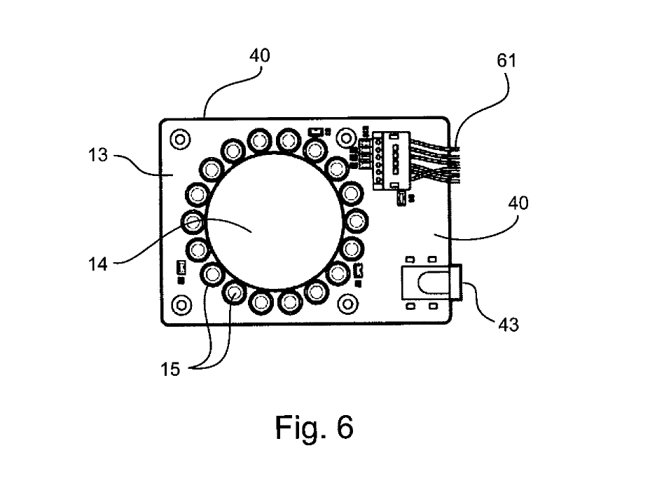

Referring now to FIG. 6, the printed circuit board 40 includes a cable connection for a cable 61 used to power and control the ringlight, and the additional power input jack 43 to power the ringlight 10 in instances where the camera 42 does not have a direct power connection.

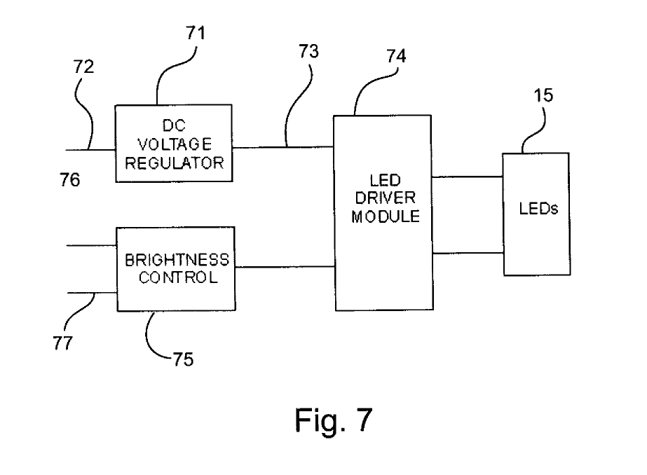

Referring to FIG. 7, a block diagram is shown illustrating the electronic components which are mounted on the printed circuit board 40. A DC voltage regulator module 71 accepts a DC input voltage 72 between 9V and 30V and converts the output voltage 73 into a controllable forward current that serves as the current source for the LED driver module 74. The brightness control module 75 has a strobe signal input 76 and a serial peripheral interface (SPI bus) input 77 and is electrically connected to the LED driver module 74. The strobe signal 76 permits the ringlight 10 to be turned on and off to synchronize the ringlight 10 with the electronic shutter of the camera 42. The SPI bus 77 is used to adjust the brightness of the ringlight 10. The SPI bus 77 and strobe signal 76 are electrically connected via the cable 16 to the camera 42. The LED driver module 74 is electrically connected to the DC voltage regulator module 71, to the brightness control module 75, and the LEDs 15 of the ringlight 10.

The ringlight 10 may be controlled through a user interface, such as through a camera or computer. The user interface is operable for controlling the functions of the ringlight. In general, the ringlight 10 can be operated in a strobe mode or a continuous mode. In continuous mode, the ringlight 10 is turned on and remains on. The brightness, intensity or power of the ringlight 10 can thus be adjusted by the user. In strobe mode, a rectangular signal is used to control the timing of the “on” and “off” cycles of the ringlight 10. The signal can be delayed with a slider control in relation to the electronic shutter speed of the camera, and the duration of the “on” and “off” cycles of the signal can be adjusted with a slider control. Furthermore, the polarity of the strobe signal can be positive or negative. The “on” and “off” cycles of the strobe signal can be synchronized by the shutter speed of the camera.

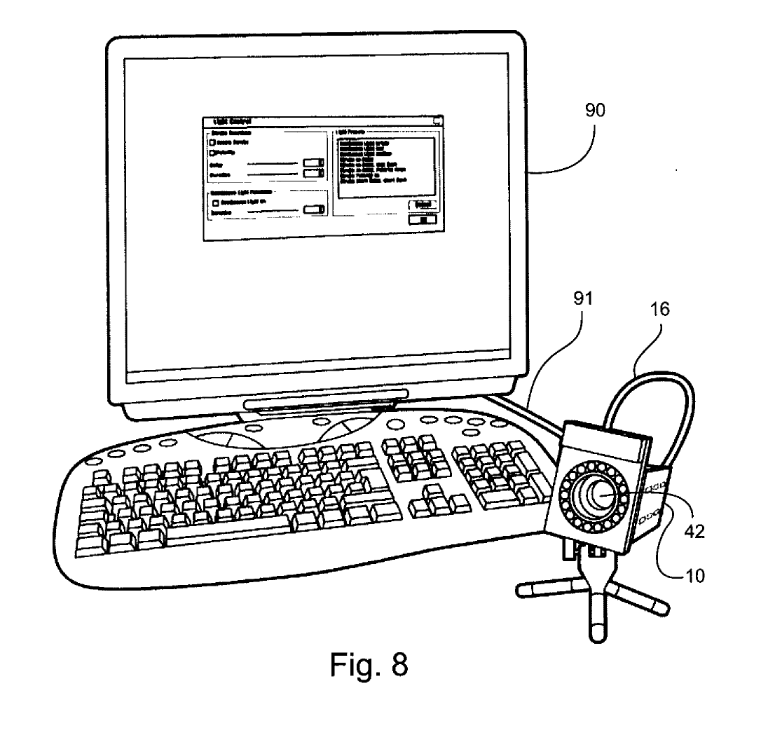

FIG. 8 shows the complete system, including a monitor 90, where the ringlight 10 is connected via the cable 16 to camera 42, and the camera 42 is connected via a cable 91 to a computer interface, such as a Firewire, USB or Ethernet connection. The computer provides a software user interface, as detailed above, to turn the ringlight 10 on/off and to control the functions of the ringlight 10. Furthermore, an application can be run on the computer that controls the ringlight 10 automatically according to predefined instructions without user interactions.

Cameras come in many different forms and sizes and due to this the embodiment of the invention is susceptible to the camera's form and size and therefore the present disclosure represents an exemplification of the principles of the invention and is not intended to limit the broad aspect of the invention to the embodiment illustrated.

An improved LED ringlight is described above. Various details of the invention may be changed without departing from the scope of the invention. Furthermore, the foregoing description of the preferred embodiment of the invention and best mode for practicing the invention are provided for the purpose of illustration only and not for the purpose of limitation, the invention being defined by the claims.

What is claimed is:

1. An image acquisition system, comprising:
a ringlight for providing illumination to an object whose image is to be acquired, and including a mounting system for a camera having a camera power supply, a camera power output jack and a camera communication jack,
a power connector electrically connected to a power input jack of the ringlight, and adapted for connection to the camera power output jack for transmitting electrical power from the camera power supply to the ringlight;
a ringlight communication jack and communication connector for interconnecting the ringlight and the camera through the camera communication jack; and
a data communication connector for connecting the camera to a computer including software for controlling the camera and the ringlight.

2. An image acquisition system according to claim 1, wherein the ringlight includes a plurality of light-emitting diodes (“LED's”) surrounding an opening in a housing through which light transmitted by the LED's onto the object is reflected from the object to the camera.

3. An image acquisition system according to claim 1, and including a cable containing both the power connector and communication connector.

4. An image acquisition system according to claim 1, wherein the software includes functions to turn the ringlight on to provide continuous illumination for a predetermined time period, to strobe the ringlight for a duration in synchronization with the camera, and to strobe the ringlight following an external signal.

5. An image acquisition system according to claim 1, and including an external power input jack to power the ringlight from a power source other than the camera.

6. An image acquisition system, including:
a ringlight connected by a power/communications cable to a camera;
the camera being adapted for connection via a communication cable to a computer communication interface; and
a software user interface adapted to turn the ringlight on and off and control a plurality of ringlight functions.

7. An image acquisition system according to claim 6, and including computer software adapted to automatically control the ringlight according to predefined software instructions without user interaction.

8. An image acquisition system according to claim 6, wherein the ringlight includes a plurality of light-emitting diodes (“LED's”) surrounding an opening in a ringlight housing through which light transmitted by the LED's onto an object is reflected from the object to the camera.

9. A ringlight for use with an image acquisition system including a camera and a computer for permitting operation of the camera and ringlight, comprising:
a DC voltage regulator module for accepting a DC input voltage and converting an output voltage into a controllable forward current that serves as a current source for the a driver module for powering illumination sources carried by the ringlight; and
a brightness control module having a strobe signal input and a serial peripheral interface bus input electrically connected to the driver module for permitting the ringlight to be turned on and off in synchronization with an electronic shutter of the camera.

10. A ringlight according to claim 9, wherein the serial peripheral interface bus input is adapted to adjust the brightness of the ringlight.

11. A ringlight according to claim 9, wherein the ringlight includes a plurality of light-emitting diodes (“LED's”) surrounding an opening in a ringlight housing through which light transmitted by the LED's onto an object is reflected from the object to the camera.

12. A ringlight according to claim 9, further comprising a mounting system for positioning the ringlight on the camera, the mounting system including side panels defining at least one slot for receiving a portion of the camera.
